(19) United States
(12) Patent Application Publication
(10) Pub. No.: US 2014/0028807 A1
(43) Pub. Date: Jan. 30, 2014

(54) OPTICAL IMAGING SYSTEM AND 3D DISPLAY APPARATUS

(71) Applicant: Zecotek Display Systems Pte. Ltd., (US)

(72) Inventors: Emine Goulanian, Richmond (CA); Nikolai A. Kostrov, Richmond (CA)

(73) Assignee: ZECOTEK DISPLAY SYSTEMS PTE. LTD., Singapore (SG)

(21) Appl. No.: 13/742,247

(22) Filed: Jan. 15, 2013

Related U.S. Application Data
(60) Provisional application No. 61/586,809, filed on Jan. 15, 2012.

(51) Int. Cl. H04N 13/04

(52) U.S. Cl. CPC H04N 13/0402
USPC 348/51

(57) ABSTRACT

An optical imaging system and related 3D display apparatus for forming different perspective views of a 3-dimensional image by transforming optical beams emanating from pixels located on a display pixel surface displaying 2-dimensional patterns and projecting the transformed optical beams in a field of view is disclosed herein. The optical imaging system comprises: an array of selecting light guide elements for reducing a radiating aperture of each pixel; a lens array of converging micro-lenses; a displacement mechanism for moving the lens array relative to the array of light guide elements in a respective plane; and a sensor system for sensing the position of the lens array relative to the array of light guide elements. The lens array together with the array of light guide elements are configured to provide at least one viewing zone in the field of view and form respective perspective views in each viewing zone by projecting therein the transformed optical beams.

### CROSS-REFERENCE TO RELATED APPLICATIONS

This application claims the benefit of priority to U.S. Provisional Application No. 61/586809, filed on Jan. 15, 2012, all of which application is incorporated herein by references in its entirety for all purposes.

### TECHNICAL FIELD

The present invention relates generally to time-sequential auto-stereoscopic systems and, more specifically, to an optical imaging system and 3D display apparatus using the same system for forming perspective views of a 3-dimensional (3D) image of an object or scene. The present invention may be useful for displays with pixels radiating as an extended light source and having wide directional diagrams (for example LCD).

### BACKGROUND OF THE INVENTION

An advantage of time-sequential autostereoscopic systems as compared with space sequential autostereoscopic systems is that time-sequential autostereoscopic systems provide high resolution of 3D images irrespective of the number of perspective views used for producing the 3D images. Up to now the high quality and high resolution 3D images in 3D display apparatus have been achieved by using displays that allow collimating optical beams emanating therefrom. However, displays with pixels radiating as extended light sources and having wide directional diagrams (for example LCD) are generally unable to provide collimation of optical beams. Consequently, employing (utilizing) such pixel radiating displays in a time-sequential 3D display apparatus using known optical imaging system is problematic.

The present invention provides a new optical imaging system that can be used in a time-sequential 3D display apparatus to produce high quality and high resolution multi view 3D images.

### SUMMARY OF THE INVENTION

An object of the present invention is to provide an optical imaging system and a 3D display apparatus having substantially suppressed or eliminated superposition of different perspective views in each viewing zone by reducing radiating aperture of each pixel on the display pixel surface (thereby solving shortcomings associated with prior art optical imaging systems).

In brief, the present invention is based on generating directional optical beams, transforming these optical beams and projecting the transformed optical beams in a field of view to form respective perspective views in each viewing zone in the field of view thereby producing a 3-dimensional (3D) image of an object or scene therein.

The present invention may be embodied in an optical imaging system and a 3D display using the same system.

In another aspect, the present invention is directed to optical imaging systems and related 3D displays based on using collimated optical beams emanating from pixels located on a display pixel surface.

As way of background, optical beams emanating from some displays (for example, LCD) have pixels with wide directional diagrams (almost 180 deg.) that impose strict limitations on the number of perspective views or even prevent the formation of 3D images. The present invention solves this problem. The present invention may be implemented by using an array of selecting light guide elements together with a lens array of converging micro-lenses in an optical imaging system and a related 3D display apparatus as disclosed herein.

The present invention builds upon the 3D display and optical imaging systems disclosed in our prior U.S. application Ser. Nos. 11/364,692 and 11/769,672, both of which applications are incorporated herein by reference in their entireties for all purposes.

These and other aspects of the present invention will become more evident upon reference to the following detailed description and attached drawings. It is to be understood, however, that various changes, alterations, and substitutions may be made to the specific embodiments disclosed herein without departing from their essential spirit and scope.

### BRIEF DESCRIPTION OF THE DRAWINGS

In the drawings like reference numerals are used to designate like features throughout the several views of the drawings. The drawings are intended to be graphic and symbolic representations of an exemplary optical imaging system and related 3D display apparatus and illustrate different structural variants and optical arrangements.

FIG. 1a is a generalized schematic view of an optical imaging system and related 3D display apparatus in accordance with an embodiment of the present invention.

FIG. 1b is a top schematic view of a portion of an optical imaging system in accordance with an embodiment of the present invention.

FIG. 2 is a top schematic view of a portion of an optical imaging system in accordance with an embodiment of the present invention that illustrates a plurality of different viewing zones.

FIG. 3 is another top schematic view of a portion of an optical imaging system in accordance with an embodiment of the present invention.

FIG. 4 is a top schematic view of a portion of a light guide element array of an optical imaging system in accordance with an embodiment of the present invention.

FIG. 5 is another top schematic view of a portion of an optical imaging system in accordance with an embodiment of the present invention.

FIG. 6 is another top schematic view of a portion of an optical imaging system in accordance with an embodiment of the present invention.

### DETAILED DESCRIPTION OF THE INVENTION

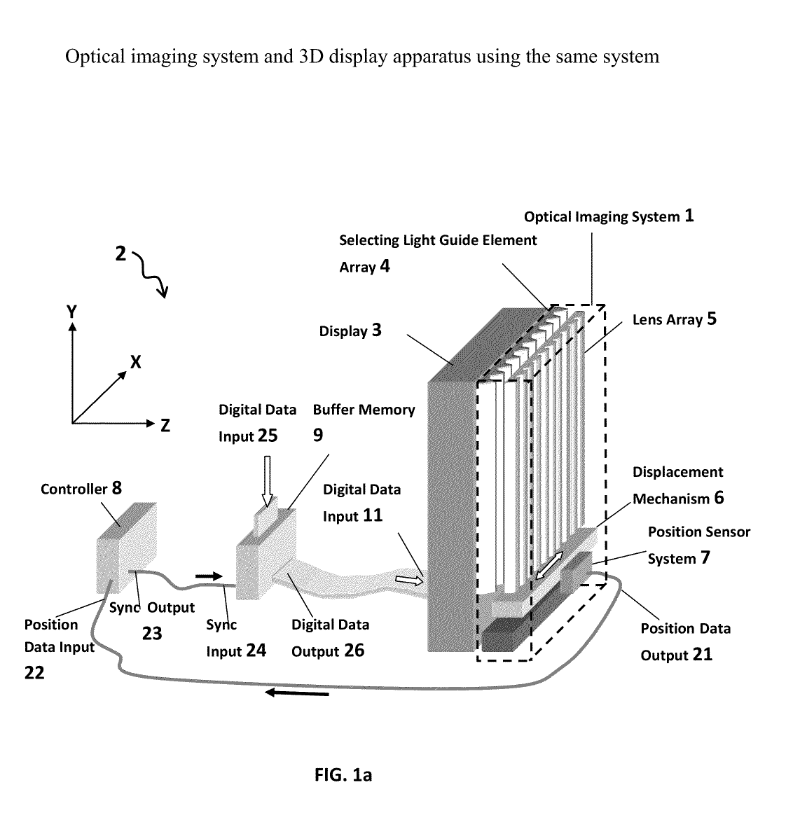

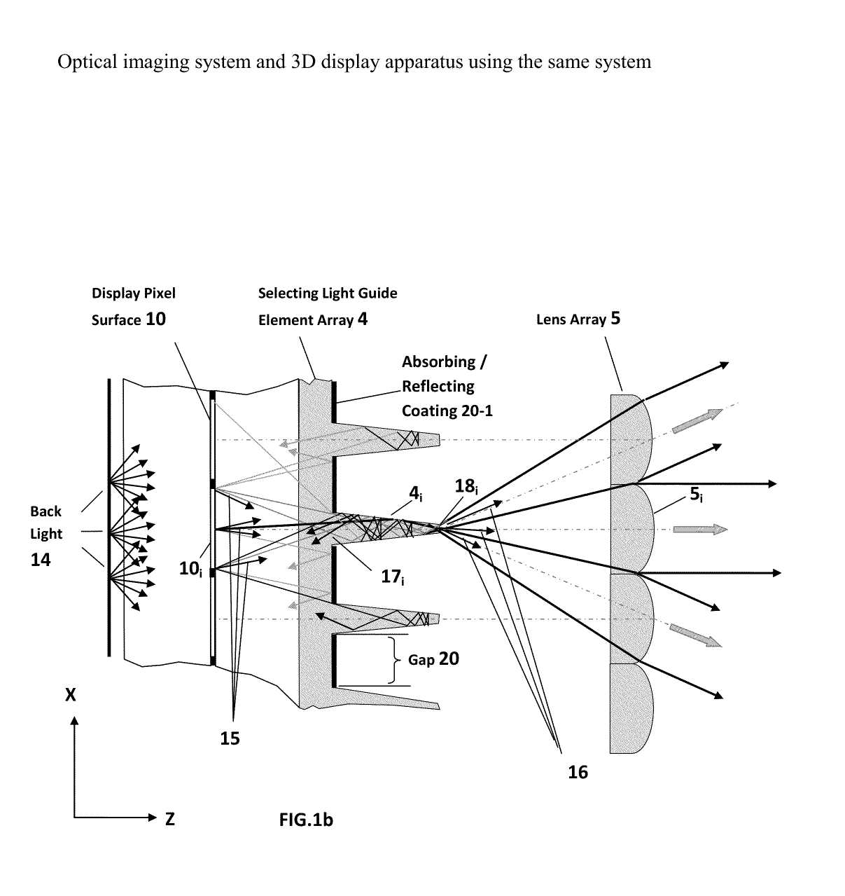

Referring now to the drawings wherein like reference numerals are used to designate identical or corresponding components or elements and, more particularly, to FIGS. 1a-6, the present invention in an embodiment is directed to an optical imaging system 1 and a related 3D display apparatus 2 using the same system. The 3D display apparatus 2 in accordance with certain embodiments of the present invention is intended for forming a plurality of perspective views of a 3-dimensional image of an object or scene in a field of view. As best shown in FIG. 1a, a block diagram of the 3D display apparatus 2 includes a display 3 (for example, LCD) displaying 2-dimensional patterns each to be projected in the direction of respective perspective views, an optical imaging system 1 (herein the optical imaging system 1 includes an array 4 of selecting light guide elements, a lens array 5 of converging micro-lenses, a displacement mechanism 6, a position sensor system 7), a controller 8 and buffer memory 9.

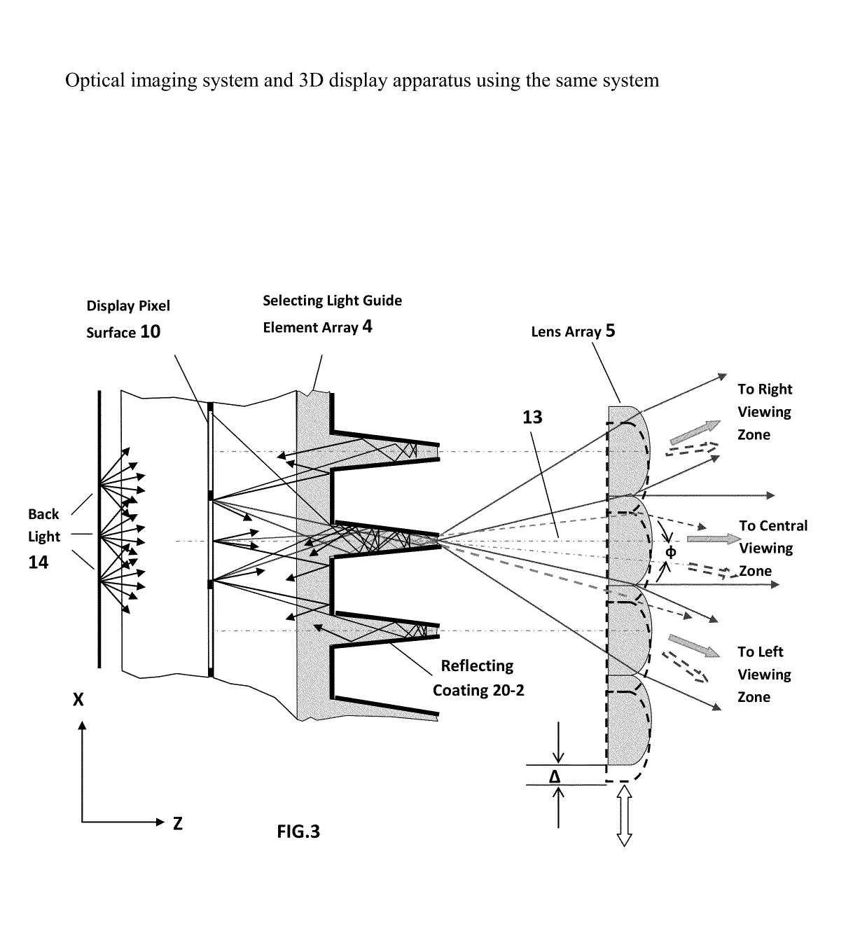

The display 3 is configured for generating 2-dimensional images (patterns) and includes a display pixel surface 10 displaying 2-dimensional images (patterns) and a digital data input 11. The display 3 also includes an array 4 of selecting light guide elements and lens array 5, which are parallel (in the exemplary embodiment shown on FIGS. 1a-b) to display pixel surface 10 and (as best shown in FIG. 3) perpendicular to an axis 13 of optical imaging system 1. Display pixel surface 10 is disposed between substrates (not designated in FIG. 1b) of the display 3 and illuminated by back light 14.

The optical imaging system 1 being used in the 3D display apparatus 2 is intended for carrying out the following functions: transforming optical beams 15 emanating from the display pixel surface 10 of display 3; projecting transformed optical beams 16 in one respective perspective view into each viewing zone in the field of view; and scanning said optical beams 16 within said viewing zone for producing the 3D image.

The function of said scanning is carried out by moving one array (lens array 5 in exemplary embodiment shown on FIG. 1b) in its plane relative to the other array (array 4 of light guide elements) with the aid of displacement mechanism 6.

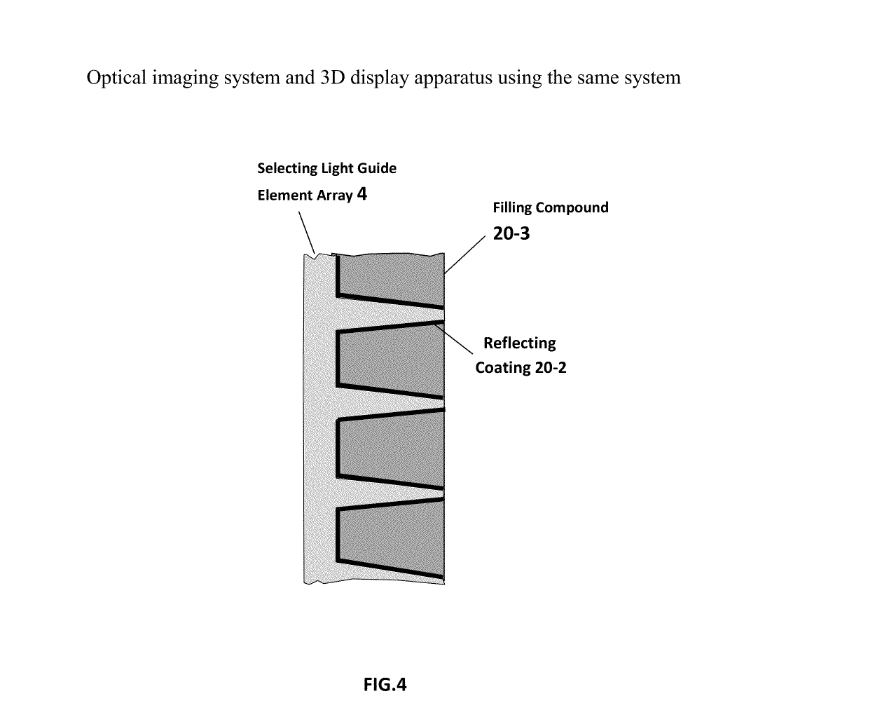

Array 4 of light guide elements represents a comb structure made of transparent optical material and is placed on outer substrate of the display 3. Each light guide element 4i of array 4 includes input aperture 17i, output aperture 18i and side walls 19i extended from input aperture 17i to output aperture 18i. Gaps 20 between input apertures of adjacent elements can be covered with nontransparent (absorbing or reflecting) coating (as in one variant shown in FIG. 1b). In another variant, side walls of each light guide element are covered with reflecting coating. The space between side walls of light guide elements can be filled with material increasing hardness of the comb structure (FIG. 4). The side walls can he made flat, curved or composed shape. Input and output walls of light guide elements can be made flat or curved.

An important consideration are relations between sizes of pixels, input apertures, output apertures of respective light guide elements and micro-lenses of lens array 5. Thus, the size of input aperture should generally be no more than pixel pitch. The size of output aperture should generally be no more than ratio of micro-lens pitch to the number of perspective views used for producing 3D image. The micro-lens pitch should generally be no more than the pixel pitch.

As best shown in FIG. 1b input aperture 17i of light guide element 4i is optically coupled to respective pixel 10i of the display pixel surface 10 whereas output aperture 18i of light guide element 4i is optically coupled to respective micro-lens 5i of the lens array 5 and located in its front focal region.

To produce horizontal parallax 3D image, lens array 5 of converging micro-lenses can be made as lenticular array with plana-convex micro-lenses vertically oriented as shown in FIG. 1a. The light guide elements of array 4 may also be extended vertically. In this case each pixel of the pixel column is optically coupled to one respective area of corresponding light guide element. Displacement mechanism 6 is configured to move the lens array 5 horizontally with respect to its relative position corresponding to the respective perspective view.

A position sensor system 7 for sensing the relative position of one array (lens array 5) in horizontal direction with respect to the other array (array 4), with the sensor system having at least one position data output 21.

To produce full parallax 3D image the array of light guide elements and lens array are made as 2-dimentional arrays of light guide elements and micro-lenses respectively, whereas displacement mechanism is configured to move the lens array both horizontally and vertically and the sensor system is configured for sensing the relative position of lens array in horizontal and vertical directions and has at least two data outputs.

The controller 8 is generally intended for synchronizing the reproduction of 2-dimensional patterns generated by the display 3 with lens array 5 movements. The controller 8 generally has at least one position data input 22 and a synchronization output 23, The position data input 22 of the controller 8 is connected to the position data output 21 of the position sensor system 7.

The buffer memory 9 has synchronization input 24, digital data input 25 for updating 2-dimensional patterns, and digital data output 26. The synchronization input 24 of buffer memory 9 is connected to synchronization output 23 of the controller 8. Digital data output 26 is connected to digital data input 11 of display 3.

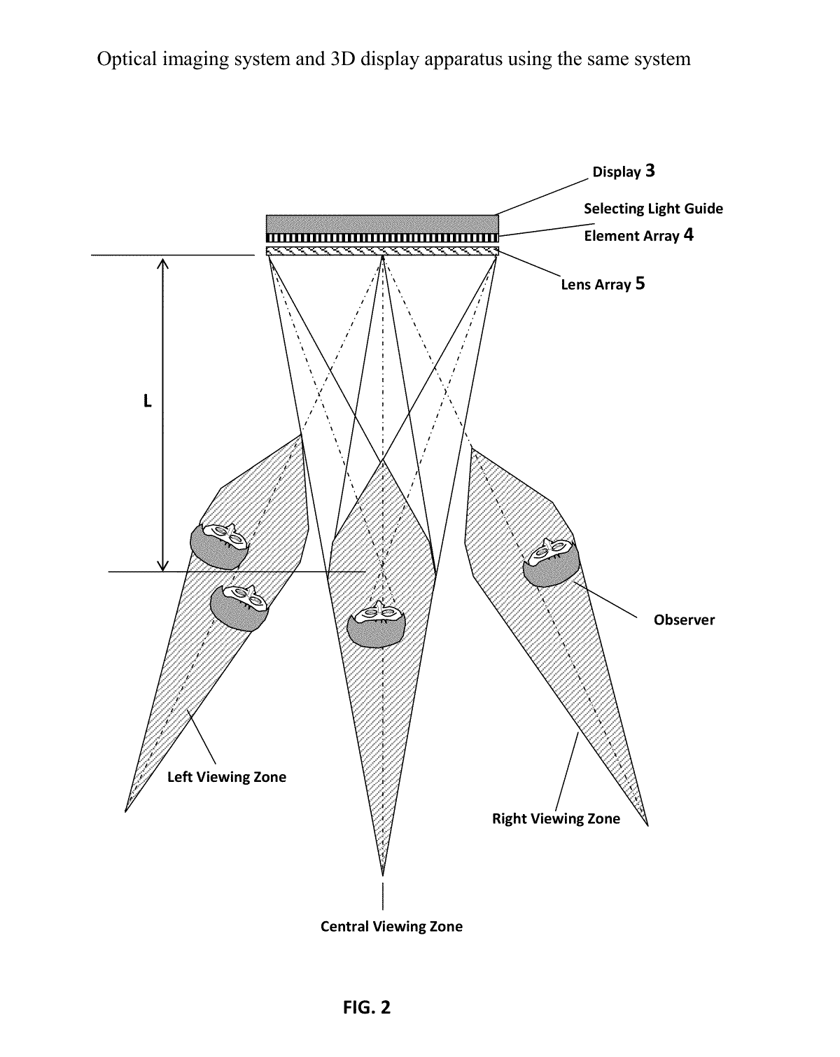

An optical imaging system 1 in accordance with an embodiment of the present invention generally operates as follows, The displacement mechanism 6 provides moving the lens array 5 of converging micro-lenses transversely relative to array 4 of selecting light guide elements. As shown in FIG. 1a, optical beams 15 emanating from the display pixel surface 10 (displaying 2-dimensional patterns) are transformed by array 4 and lens array 5 into optical beams 16. The transformed optical beams 16 form each perspective view to be projected in viewing zones of the field of view (some viewing zones are illustrated in FIG. 2).

Displacement mechanism 6 is configured to perform the horizontal movement in a reciprocating fashion (see FIG. 3). Thereby, perspective views are scanned consistently in viewing zones for producing 3D image therein. As shown in FIG. 3 horizontal displacement Δ of lens array 5 results in changing angle of projected optical beams 16 for amount of Φ:

Φ=a tan(Δ/F),

where F is focal length of lens 5i (see FIG. 1b),

A 3D display apparatus 2 in accordance with another embodiment of the present invention operates as follows, As shown in FIG. 1a, optical beams 15 emanating from the display pixel surface 10 (illuminated by back light 14 and displaying 2-dimensional patterns) are transformed by array 4 and lens array 5 into optical beams 16. The transformed optical beams 16 form each perspective view to be projected in viewing zones of the field of view (some viewing zones are illustrated in FIG. 2). The displacement mechanism 6 provides moving the lens array 5 of converging micro-lenses transversely relative to array 4 of selecting light guide elements in a reciprocating fashion. Thereby, perspective views are scanned consistently in viewing zones for producing 3D image therein. Signals from position sensor system 7 are used by controller 8 for synchronizing the sequence of 2-dimensional patterns generated by the display 3 with the movement of lens array 5.

The array 4 of light guide elements is intended for carrying out the following functions. Each element 4i of array 4: selects optical beams 15 emanating from respective pixel 10i, propagating through input aperture 17i and reflecting from side walls 19i converges selected optical beams into output aperture 18i for reducing radiating aperture of said pixel 10i; and suppresses optical beams emanating from pixels adjacent to pixel 10i.

Optical beam reflection from side walls 19i of light guide element 4i shown in FIG. 1b is accomplished due to total internal reflection. Gaps between elements are covered with absorbing or reflecting coating 20-1.

In another variant of array 4 shown in FIG. 3, the reflection of selected optical beams from side walls of its elements is accomplished by reflecting coating 20-2 covering side walls and gaps between elements.

In one more variant of array 4 shown in FIG. 4, side walls and gaps between elements are covered with reflecting coating 20-2, the space between side walls of light guide elements is filled with compound 20-3 increasing resiliency and hardness of the comb structure of array 4.

A peculiarity of the structure of array 4 consists in that effectiveness of selection and suppression of said optical beams is increased with reducing the distance between display pixel surface 10 and input apertures of light guide elements. This allows increasing brightness and quality of 3D image produced. Another peculiarity of the structure of array 4 consists in that side wails as well as input and output walls of light guide elements can be made flat, curved or composed shape depending on technological requirements and specific applications of the optical imaging system and the 3D display apparatus. All of this allows providing functional flexibility and adaptability of the optical imaging system and the 3D display apparatus.

The lens pitch of lens array 5 can be equal to pixel pitch of display pixel surface 10. Meanwhile, it requires using additional converging optical element (for example, Fresnel lens) to maximize viewing zone width at required distance L from lens array of 3D apparatus (see FIG. 2).

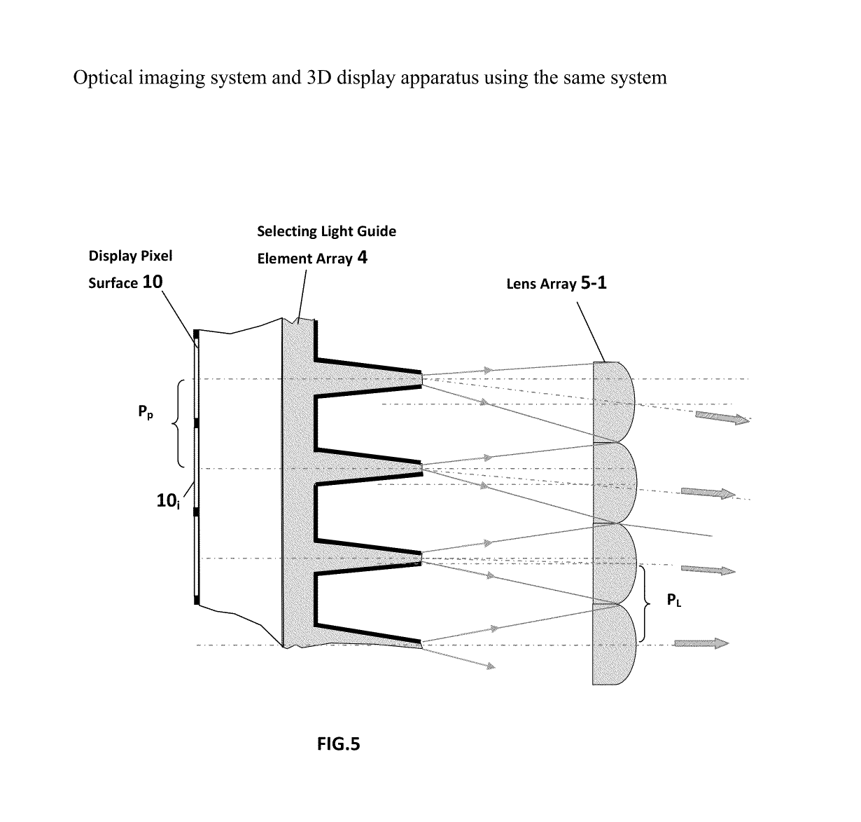

In other variant said maximizing viewing zone width can be achieved by using lens array 5-1 with lens pitch less than pixel pitch as shown in FIG. 5. In this variant maximum viewing zone width is achieved at distance L from lens array of 3D apparatus:

L=F/(1−P_{L}/P_{P})

where F focal length of lenses in lens array

P_{L}—lens pitch

P_{P}—pixel pitch

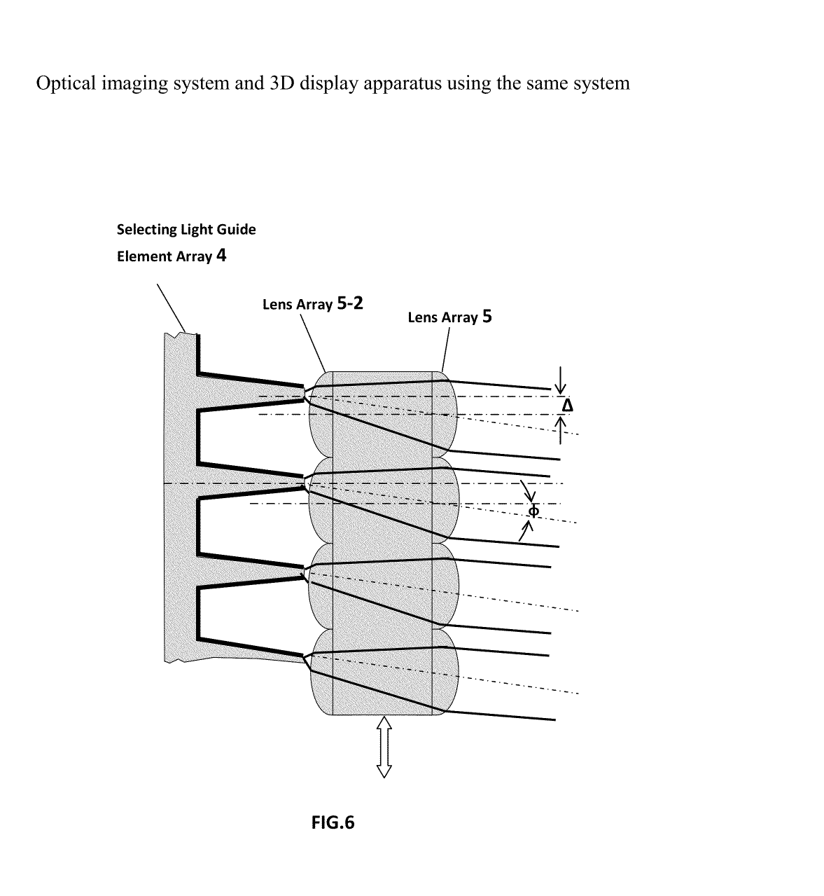

The optical imaging system and 3D display apparatus can comprise additional planoconvex lens array 5-2 Which is combined with lens array 5 such that lens array 5-2 is located at the front focal region (see FIG. 6). This allows increasing brightness of each perspective view and 5 reducing or eliminating superposition of different perspective views in viewing zones. In FIG. 6 lens arrays 5 and 5-2 are mounted on common substrate (not designated).

While the present invention has been described in the context of the embodiments illustrated and described herein, the invention may be embodied in other specific ways or in other specific forms without departing from its spirit or essential characteristics. Therefore, the described embodiments are to be considered in all respects as illustrative and not restrictive. The scope of the invention is, therefore, indicated by the appended claims rather than by the foregoing description, and all changes that come within the meaning and range of equivalency of the claims are to be embraced within their scope.

What is claimed is:

1. An optical imaging system for forming different perspective views of a 3-dimensional image of an object or scene by transforming optical beams emanating from pixels located on a display pixel surface that is displaying 2-dimensional patterns and projecting the transformed optical beams in a field of view, comprising:
an array of selecting light guide elements for reducing a radiating aperture of each pixel, wherein an input aperture of each light guide element is optically coupled to a respective pixel of the display pixel surface;
a lens array of converging micro-lenses, wherein each micro-lens of the lens array is optically coupled to an output aperture of each respective light guide element, wherein each output aperture is located in a front focal region of the lens array;
a displacement mechanism for moving the lens array relative to the array of light guide elements in a respective plane;
a sensor system for sensing the position of the lens array relative to the array of light guide elements, wherein the sensor system includes at least one data output;
and wherein the lens array together with the array of light guide elements are configured to provide at least one viewing zone in the field of view and form respective perspective views in each viewing zone by projecting therein the transformed optical beams.

2. A time-sequential 3D display apparatus, comprising:
an optical imaging system configured to transform optical beams emanating from pixels located on a pixelated display surface displaying a 2-dimensional image and projecting the transformed optical beams in a field of view, wherein the optical imaging systems comprises:
an array of selecting light guide elements for reducing a radiating aperture of each pixel, wherein an input aperture of each light guide element is optically coupled to a respective pixel of the pixelated display surface;
a lens array of converging micro-lenses, wherein each micro-lens of the lens array is optically coupled to an output aperture of a corresponding light guide element, wherein each output aperture is located in a front focal region of the lens array;
a displacement mechanism for moving the lens array relative to the array of light guide elements in a respective plane;
a sensor system for sensing the position of the lens array relative to the array of light guide elements;
and wherein the lens array together with the array of light guide elements are configured to provide at least one viewing zone in the field of view and form respective perspective views in each viewing zone by projecting therein the transformed optical beams.
